(19) United States
(12) Patent Application Publication
(10) Pub. No.: US 2006/0209031 A1
(43) Pub. Date: Sep. 21, 2006

(54) Hand held communications computer and keyboard

(76) Inventor: James W. Burrell IV, Union, NJ (US)

Correspondence Address: Ezra Sutton, Esq., Plaza 9, 900 Route 9, Woodbridge, NJ, 07095, US

(21) Appl. No.: 11/083,752

(22) Filed: Mar. 18, 2005

(51) Int. Cl. G09G 5/00

(52) U.S. Cl. 345/169

(57) ABSTRACT

A portable hand held communications computer terminal with data, audio and video communications capabilities using a rearranged QWERTY keyboard for the visually impaired, mobility impaired and the masses designed for one finger operation. The portable hand held computer terminal includes a microprocessor, a battery and standard plug type connection for powering the microprocessor, a rearranged QWERTY keyboard and a data input system for entering data into the microprocessor, a display screen and data output circuit for displaying data from the microprocessor, a data storage circuit for storing data converted to and from the microprocessor, a plurality of control keys for operating in a plurality of modes, an internal microphone and audio storage circuit, a connection for an external microphone and speaker for listening, recording, transmitting and storing audio data, an optical recording device and video storage circuit for recording, storing and transmitting visual data, an antennae and a means for wirelessly transmitting and receiving data to and from an external source, and a plurality of connection ports for transmitting and receiving data. The device can also include a bar code reader and means for scanning bar code data from an external source, an infrared data port and means for transmitting and receiving infrared data or any other type of data port for increasing the usability and compatibility of the device. A securing strap or snug fitting sleeve attached on the bottom of the device is used for attaching the device to an appendage for portability and ease of use.

### FIELD OF THE INVENTION

This invention relates to a portable hand held computer terminal and keyboard. This invention also relates to a portable hand held computer terminal with data communications capabilities combined with audio and video communications capabilities.

### BACKGROUND OF THE INVENTION

Keyboards, portable computers and similar devices for entering data through a keyboard are limited to size due to the size of the keyboard. The finger activated keys on the keyboard were replaced by shrinking the QWERTY keyboard and using a stylus or a pen to activate labeled touch zones.

There remains a need for a portable hand held computer terminal and keyboard designed for one handed operation with finger activated keys or sensors for the visually impaired, mobility impaired and the masses.

### DESCRIPTION OF THE PRIOR ART

Typewriters, computers with keyboards, portable computers, laptops, handheld computers, PDAs and similar devices for entering data through a keyboard have always conformed to the original QWERTY keyboard arrangement. The improved Dvorak keyboard arrangement was tested by the U.S. Navy and found to be around twenty percent faster to use than the QWERTY keyboard. The QWERTY keyboard arrangement was already being used for generations all over the world and change would mean reeducating the masses and throwing out all QWERTY keyboard products.

Accordingly, it is an object of the present invention to provide a portable hand held communications computer terminal and keyboard arrangement designed for one finger operation by the visually impaired, mobility impaired and the masses.

### SUMMARY OF THE INVENTION

In accordance with the present invention, there is provided a portable hand held computer terminal and keyboard. The portable hand held computer terminal and keyboard includes a microprocessor, an internal power source for powering the microprocessor, a connection for external power source for powering the microprocessor and for charging the internal power source, a keyboard for entering data into the microprocessor, a data storage circuit for storing data converted to the microprocessor, a display screen and a data output circuit for displaying data from the microprocessor, four sensors for moving a cursor in four different directions on the display screen, a phone keypad for entering numeric data, and a plurality of control keys for operating in a plurality of modes, a microphone and data storage circuit for recording, storing and transmitting audio data, along with a connection for an external microphone and speaker for listening, recording and storing audio data, an optical recording device and data storage circuit for recording, storing and transmitting visual data, an antennae and a means for wirelessly transmitting and receiving data to and from an external source, and a plurality of connection ports for transmitting and receiving data through the ports. Adding a bar code reader and:a means for scanning bar code data from an external source increases the usability of the portable hand held computer terminal. Adding an infrared data port or any other kind of data port and a means for transmitting and receiving infrared data or any other type of data also increases the usability of the portable hand held computer terminal.

The portable hand held computer terminal can also use a securing strap(s) or snug fitting sleeve attached on the bottom of said portable hand held mobile computer to secure to the arm or leg for portability and ease of use.

The alphanumeric QWERTY keyboard has been rearranged to produce all QWERTY keyboard data on separate sensors and all functions are produced on separate sensors. The alphanumeric keyboard has the backspace function sensor located on the left side of the space bar and the delete function sensor located on the right of said space bar. Left containment character sensors are located on the left side of the alphanumeric keyboard and right containment character sensors are located on the right side of the alphanumeric keyboard.

The alphanumeric keyboard has a numbered keypad using a numeric phone keypad arrangement. This replaces the 1 through 9 keys and 0 key on alphanumeric QWERTY type keyboards. The asterisk sensor produces the asterisk data character and the pound sensor produces the pound data character.

The actuation keys on standard computer keyboards have been changed to clear touch sensitive screen coverings over thin and flat display screens. Using this technology, one large display screen can easily be programmed to be used as a keyboard and the data display. Using a domed shaped key top configuration will increase tactile responsiveness and reduce keystroke errors.

The personal computer, laptops, notebooks, tablets, PDAs, personal communications devices and the like has become smaller, faster, and less expensive and most use Windows based programs to operate various compatible software packages for data entry and retrieval.

### BRIEF DESCRIPTION OF THE DRAWINGS

Further objects, features, and advantages of the present invention will become apparent upon the consideration of the following detailed description of the presently-preferred embodiment when taken in conjunction with the accompanying drawings, wherein:

FIG. 1 is a top perspective view of the portable hand held computer terminal and keyboard using a thin display screen with a touch sensitive overlay showing the rearranged QWERTY keyboard arrangement.

### DETAILED DESCRIPTION OF THE PREFERRED EMBODIMENT

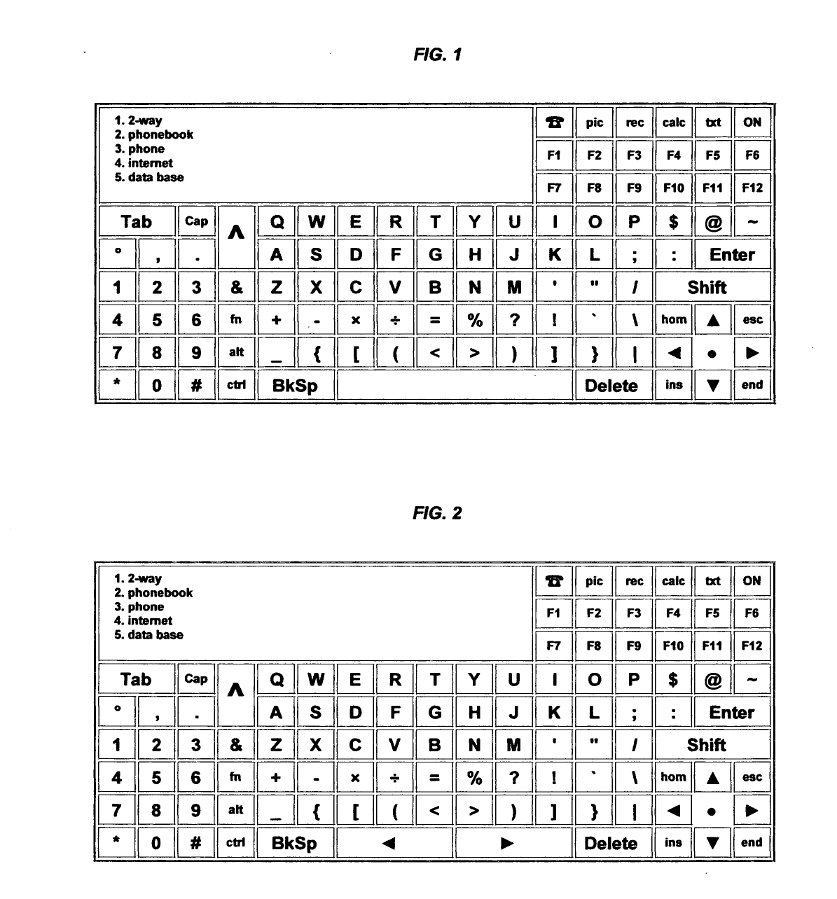

The portable hand held computer terminal and rearranged QWERTY keyboard are shown in one preferred embodiment using a thin display screen with a touch sensitive overlay, represented in detail by FIG. 1. The portable hand-held computer terminal includes a microprocessor for storing operating programs, databases, processing data, storing data, displaying data through a display screen or any needed process.

A battery is used as an internal power source for powering the microprocessor, the display screen, the touch sensitive display screen, the microphone and data storage circuit, the external microphone and speaker, the optical recording device and data storage circuit, the antennae and a means for wirelessly transmitting and receiving data, connection ports for transmitting and receiving data or to power or use a peripheral device.

The portable hand held computer terminal and keyboard uses a standard plug type connection for powering, from any standard electrical outlet, the microprocessor, all peripheral devices connected to the portable hand held computer terminal and for charging the battery.

The alphanumeric QWERTY keyboard has been rearranged to allow for entering data on the keyboard using only one finger. Every character and function is assigned a separate sensor. The standard QWERTY keyboard uses the 1 through 9keys and 0 key to produce numbers and allows shifting to produce ten extra symbols. When typing with only one finger, it is very difficult to shift and press a second key to produce a data character. The 1 through 9 keys and 0 key produce ten numbers and ten symbols. The standard QWERTY keyboard also has eleven symbol keys to produce common symbols and punctuation and shifts into a second set of symbols and punctuation. The standard QWERTY keyboard has 21 keys, used to produce 42 symbols and punctuation marks. The portable hand held computer terminal and keyboard uses 42 sensors to produce 42 symbols and punctuation marks.

The semicolon sensor [;] and colon sensor [:] are located on the same row next to each other. The apostrophe sensor ['] and quote sensor [”] are located on the same row next to each other. The question mark sensor [?]and apostrophe sensor [!]are located on the same row next to each other. The slash sensor [/], backslash sensor [\] and vertical line sensor [|]are located on the same row next to each other. The function sensor [fn], alternate function sensor [alt] and control function sensor [ctrl] are adjacent to each other.

The degree symbol [°] sensor has been added as extra key and symbol. The mathematical function sensors: plus [+] sensor, minus [−] sensor, multiplication [×] sensor, division [÷] sensor, equals [=] sensor and percent [%] sensor are preferably located on the same row next to each other. Standard QWERTY keyboards do not have the multiplication [×] sensor as a mathematical function or the division [÷] sensor as a mathematical function sensor. Left containment character sensors; the left brace symbol [{] and sensor, the left bracket symbol [] and sensor, the left parenthesis [(] and the left less than symbol [<] and sensor are located on sensors positioned preferably together on the left side of the alphanumeric keyboard and right containment character sensors; the right greater than symbol [>] and sensor, the right parenthesis symbol [)] and sensor, the right bracket symbol [] and sensor, the right brace symbol [}] and sensor, are located on sensors positioned preferably on the right side of the alphanumeric keyboard.

The alphanumeric keyboard has the backspace function sensor located on the left side of the space bar and the delete function sensor located on the right of said space bar. Four sensors for moving a cursor in four different directions on the display screen are shown in FIG. 1, unlike standard computer keyboards which use the down key positioned between the left cursor key and the right cursor key. There are also a plurality of control keys for operating in a plurality of modes. There are twelve function keys [F1] through [F12] on the portable hand held computer terminal and keyboard, the same as the standard computer keyboard, along with the [ctrl] key, [alt] key, [fn] key, [cap] key, [insert] key, [home] key, [end] key and [esc] key.

The space bar is divided into a left space bar and a right space bar. Activating the left space bar and the right space bar simultaneously exits a space bar mode and enters a cursor movement mode. Activating the left space bar moves the cursor to the left and activating the right space bar moves the cursor to the right. Activating the left space bar and the right space bar simultaneously exits the cursor movement mode and returns to the space bar mode.

The space bar is divided into a left space bar and a right space bar. Activating the left space bar and the right space bar simultaneously exits a space bar mode and enters a cursor movement mode. Activating the left space bar moves the cursor to the left and activating the right space bar moves the cursor to the right. Activating any sensor other than the left space bar or the right space bar exits the cursor movement mode and returns to the space bar mode.

The carat [ˆ] sensor is positioned to the left of the alphabetic keyboard spanning the two top rows starting with the [Q] sensor and the [A] sensor. The carat [ˆ] sensor is never used by the normal computer keyboard user. The portable hand held computer terminal keyboard uses the carat [ˆ] sensor as a second shift key. When the carat [ˆ] symbol has to be produced, the keyboard user activates the carat [ˆ] sensor combined with the shift sensor.

The alphanumeric keyboard uses a numeric phone keypad arrangement, making it easier to enter a phone number. The numeric phone keypad arrangement replaces the 1 through 9 keys and 0 key on alphanumeric QWERTY type keyboards. The symbols on the 1 through 9 keys and 0 key are each produced by an additional separate key. The asterisk sensor [] on the numeric phone keypad arrangement produces the asterisk data character and the pound sensor [#] produces the pound data character. The comma sensor [,] and the period sensor [.] are located on the same row next to each other and are adjacent to the numeric keypad.

The portable hand held computer terminal uses a data storage circuit for storing data converted to and from the microprocessor, more commonly known in the art as RAM. The internal dimensions of the portable hand held computer terminal dictate RAM processing speeds, due to the fact that faster RAM processing speeds require more room for components.

The portable hand held computer terminal and keyboard, which is shown in FIG. 1 in one preferred embodiment, uses a thin display screen with a touch sensitive overlay and a data output circuit for displaying data from the microprocessor. The thin display screen can easily be made as a paper thin OLED screen, a liquid crystal display (LCD) or any other similar display technology. The touch sensitive overlay can be either an analog matrix touch sensitive overlay, a digital matrix touch sensitive overlay or any other finger positioning location technology.

The portable hand held computer terminal also includes an internal microphone and data storage circuit for recording, storing and transmitting audio data, along with a connection for an external microphone and speaker for listening, recording, transmitting and storing audio data. The internal microphone, preferably a directional microphone, will work best if it is located on the top of the portable hand held computer terminal or located in a position where the audio input will not be blocked or be able to pick up background noise.

The portable hand held computer terminal also includes an optical recording device and data storage circuit for recording, storing and transmitting visual data. The optical recording device can be a digital camera type device, a closed circuit television type device or any other type of optical recording device. By positioning a second optical recording device facing in the opposite direction of the first optical recording device (180degrees), the portable hand held computer terminal can record or transmit visual data from the front and back of the user. The optical recording device and data storage circuit are limited to resolution and frames per second because of the compact size. As technology advances an camera and video technology becomes smaller and faster, the visual data resolution and frames per second recording speed will improve.

The portable hand held computer terminal also includes an antennae and a means for wirelessly transmitting and receiving data to and from an external source. The antennae will be preferably located on the surface of the portable hand held computer terminal or embedded within the portable hand held computer terminal The antennae must be designed to accommodate the transmitting and receiving frequency of the external source. The transmitting and receiving-frequency will preferably be any 2-way frequency: MTS (Mobile Telephone Service), IMTS (Improved Mobile Telephone Service), AMPS (Advanced Mobile Phone Service), NAMPS (Narrowband Advanced Mobile Phone Service), TDMA (Time Division Multiple Access), CDMA (Code Division Multiple Access), W-CDMA (Wideband Code Division Multiple Access), GSM (Global Systems for Mobile communications), GSM-NA (Global Systems for Mobile communications-North America), PACS (Personal Access Communications Systems), PCS (Personal Communications Services), SMR (Specialized Mobile Radio), ESMR (Enhanced Specialized Mobile Radio) and the like.

The portable hand held computer terminal also includes a plurality of connection ports to connect peripheral devices for transmitting and receiving data. Using the USB port or any integrated port to connect a digital scanner or digital fingerprint reader, law enforcement can have identity conformation at their fingertips. Using the optical recording device to record and transmit an image of a suspect, law enforcement can have almost instantaneous identity conformation. Adding a bar code reader and a means for scanning bar code data from an external source or adding an infrared data port and a means for transmitting and receiving infrared data further increases the usability of the portable hand held computer terminal. Adding any other kind of data port and a means for transmitting and receiving any other type of data also further increases the usability and compatibility of the portable hand held computer terminal. The most common standard port for transmitting data is the Universal Serial Port (USB 2.0) data port, but any data transmission port will suffice such as the USB 1.1port, Firewire port, Serial port, Ethernet port, Phone Jack port, S-Video port, wireless connection or any present or future standard or non-standard communications port.

The common actuation keys on standard computer keyboards have been replaced on the preferred embodiment shown in FIG. 1 by clear touch sensitive screen coverings over a thin and flat display screen. Using this technology, one large display screen can easily be programmed to be used as a keyboard and data display screen. Using a domed shaped key top configuration on a smaller key type actuation keyboard will increase tactile responsiveness and reduce keystroke errors on the smaller area finger tip touch surfaces. The flat panel display can exit the full display keyboard mode and enter a full display graphics mode or a split screen display mode for viewing optical data or video data.

The portable hand held computer terminal can also use a securing strap(s) or snug fitting sleeve attached on the bottom of said portable hand held mobile computer to secure to an appendage, the arm or leg, for portability and ease of use.

Accordingly, an advantage of the present invention is that it provides instant reception or transmission of data, whether it may be binary data, audio data or visual data through the portable hand held computer terminal and keyboard.

Another advantage of the present invention is that it provides improved one finger data entry capabilities using a rearranged QWERTY keyboard arrangement. Repositioning of specific sensors increases data entry speeds.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

I claim:

1. A portable hand held communications computer comprising:
a) a microprocessor;
b) an internal power source for powering said microprocessor;
c) means for connecting said microprocessor to an external power source for powering said microprocessor and for charging said internal power source;
d) a keyboard for entering data into said microprocessor;
e) a data storage circuit for storing data converted to said microprocessor;
f) a display screen;
g) a data output circuit for displaying data from said microprocessor on said display screen;
h) said keyboard having four sensors for moving a cursor in four different directions on said display screen;
i) said keyboard having a phone keypad for entering numeric data;
j) said keyboard having a plurality of mode entry sensors for operating in a plurality of modes:
1) a phone sensor for entering a phone mode; and
2) a picture sensor for entering a picture mode; and
3) a record sensor for recording audio and visual data; and
4) a calculator sensor for entering a calculator mode; and
5) a text sensor for entering a text entry mode;
k) an internal microphone;
1) a data storage circuit for recording, storing and transmitting audio data from said internal microphone;
m) means for connecting an external microphone and speaker to said a data storage circuit for recording and storing audio data;
n) an optical recording device for recording visual data;
o) a data storage circuit for recording, storing and transmitting visual data from said optical recording device;
p) an antennae;
q) means for wirelessly transmitting and receiving data to and from an external source; and
r) a plurality of connection ports located in said portable hand held mobile computer for transmitting and receiving data through said ports.

2. A portable hand held communications computer, in accordance with claim 1, further comprising:
a) an internal speaker; and
b) a circuit for transmitting audio data from said internal speaker.

3. A portable hand held communications computer, in accordance with claim 1, further comprising:
a) an infrared data port; and
b) means for wirelessly transmitting and receiving infrared data to and from an external source.

4. A portable hand held communications computer, in accordance with claim 1, further comprising:
a) a bar code reader; and
b) means for scanning bar code data from an external source.

5. A portable hand held communications computer, in accordance with claim 1, further comprising:
means of securing said portable hand held mobile computer to an appendage.

6. An alphanumeric keyboard arrangement producing all QWERTY keyboard data wherein:
a) all data characters are produced by separate sensors; and
b) all functions are produced by separate sensors.

7. An alphanumeric keyboard arrangement producing all QWERTY keyboard data, in accordance with claim 6, wherein:
a) left containment character sensors are located on the left side of said alphanumeric keyboard; and
b) right containment character sensors are located on the right side of said alphanumeric keyboard.

8. An alphanumeric keyboard arrangement producing all QWERTY keyboard data, in accordance with claim 6, wherein:
a degree character sensor is located on said alphanumeric keyboard.

9. An alphanumeric keyboard arrangement producing all QWERTY keyboard data, in accordance with claim 6, wherein:
mathematical function character sensors are located on the same row next to each other on said alphanumeric keyboard.

10. An alphanumeric keyboard arrangement producing all QWERTY keyboard data, in accordance with claim 6, wherein:
a comma character sensor and a period character sensor are located on the same row next to each other and are adjacent to a numeric keypad on said alphanumeric keyboard.

11. An alphanumeric keyboard arrangement producing all QWERTY keyboard data, in accordance with claim 6, wherein:
a semicolon character sensor and a colon character sensor are located on the same row next to each other on said alphanumeric keyboard.

12. An alphanumeric keyboard arrangement producing all QWERTY keyboard data, in accordance with claim 6, wherein:
a apostrophe character sensor and a quote character sensor are located on the same row next to each other on said alphanumeric keyboard.

13. An alphanumeric keyboard arrangement producing all QWERTY keyboard data, in accordance with claim 6, wherein:
a question mark character sensor and a exclamation mark character sensor are located on the same row next to each other on said alphanumeric keyboard.

14. An alphanumeric keyboard arrangement producing all QWERTY keyboard data, in accordance with claim 6, wherein:
a slash character sensor, a backslash character sensor and a vertical line character sensor are adjacent to each other on said alphanumeric keyboard.

15. An alphanumeric keyboard arrangement producing all QWERTY keyboard data, in accordance with claim 6, wherein:
a function sensor, a alternate function sensor and a control function sensor are adjacent to each other on said alphanumeric keyboard.

16. An alphanumeric keyboard arrangement producing all QWERTY keyboard data, in accordance with claim 6, wherein:
F1, F2, F3, F4, F5 and F6 function sensors are located on the same row next to each other and F7, F8, F9, F10, F11 and F12 function sensors are located on the same row next to each below said F1, F2, F3, F4, F5 and F6 function sensors on said alphanumeric keyboard.

17. An alphanumeric keyboard arrangement producing all QWERTY keyboard data, in accordance with claim 6, wherein:
a) a carat character sensor is located on the left side of an alphabetic keyboard; and
b) activation of said carat character sensor produces a shift function; and
c) activation of said carat character sensor combined with the shift function sensor produces a carat character.

18. An alphanumeric keyboard arrangement wherein:
a) a backspace function sensor is located to the left of the space bar; and
b) a delete function sensor is located to the right of said space bar.

19. An alphanumeric keyboard arrangement wherein:
a) a space bar is divided into a left space bar and a right space bar, and
b) said left space bar and said right space bar are divided into two equal parts; and
c) activating said left space bar and said right space bar simultaneously exits a space bar mode and enters a cursor movement mode; and
d) activating said left space bar moves a cursor to the left and activating said right space bar moves said cursor to the right.

20. An alphanumeric keyboard arrangement, in accordance with claim 19, wherein:
activating said left space bar and said right space bar simultaneously exits said cursor movement mode and returns to said space bar mode.

21. An alphanumeric keyboard arrangement, in accordance with claim 19, wherein:
activating any sensor other than said left space bar or said right space bar exits said cursor movement mode and returns to said space bar mode.

22. An alphanumeric keyboard arrangement for computer keyboards wherein:
a numbered keypad, including an asterisk character sensor and a pound character sensor, is displayed in a numeric phone keypad arrangement, replacing 1 through 9 and 0 keys on an alphanumeric keyboard.

23. An alphanumeric keyboard arrangement wherein a numeric keypad is displayed in a phone keypad arrangement, in accordance with claim 22, wherein:
a) activating said numeric character sensors produces numeric data characters; and
b) activating a pound character sensor produces a pound data character; and
c) activating an asterisk character sensor produces an asterisk data character.
